(19) United States
(12) Patent Application Publication
(10) Pub. No.: US 2016/0228925 A1
(43) Pub. Date: Aug. 11, 2016

(54) Cosmetic Brush Cleaning Assembly

(71) Applicant: Erika V. Frantsevich, (US)

(72) Inventors: Erika V. Frantsevich, Kent, WA (US); Ella Aleksandrovna Stefoglo, Seattle, WA (US); Samuel Taylor Weaver, Bellingham, WA (US)

(21) Appl. No.: 15/040,995

(22) Filed: Feb. 10, 2016

Related U.S. Application Data
(60) Provisional application No. 62/114,410, filed on Feb. 10, 2015.

(51) Int. Cl. B08B 3/04

(52) U.S. Cl. CPC B08B 3/04

(57) ABSTRACT

An assembly that can allow easier and more effective cleaning of cosmetic brushes is provided. Washing of brushes is performed within a cleaning chamber using rotation of a holder of cosmetic brushes, with brushes coming into a contact with semi-rigid filament that facilitate removal of dirt and a washing medium during the rotation. The washing medium is pumped into the cleaning chamber from one chamber of a reservoir, and is pumped after being used from the cleaning chamber into a different chamber of the reservoir. The base of the assembly includes components that allow controlling the operations of the assembly, either manually or using one or more preprogrammed routines. An additional compartment is provided for storing cosmetic brushes and washing accessories, such as soap bottles.

### CROSS-REFERENCE TO RELATED APPLICATION

This non-provisional patent application claims priority under 35 U.S.C. §119(e) to U.S. Provisional Patent application, Ser. No. 62/114,410, filed Feb. 10, 2015, the disclosure of which is incorporated by reference.

### FIELD

This application relates in general to cosmetics, and, in particular, to a cosmetic brush cleaning assembly.

### BACKGROUND

Application of cosmetics, also known as makeup, is an integral part of many people's daily rituals as well as events such as weddings, photo-shoots, and acting performances. Regardless of whether cosmetics is applied by a person in the comfort of that person's home or by a professional makeup artist, in a salon or another setting, the application usually involves using cosmetic brushes, also known as makeup brushes. Such brushes can vary in shape and size but all have bristles to which makeup adheres and which transfer the makeup to a person's skin. For example, foundation brushes, which usually have long and flat bristles with a tapered tip, are used to apply makeup foundation: a layer of makeup that applies a uniform color to a person's skin and serves as a base for other makeup. A different brush, whose bristles usually take a rounded shape, is used to apply cosmetic powder. A multitude of other brushes, such as blush brushes, concealer brushes, and mineral powder brushes, are used to apply other makeup elements.

Despite the differences in the shape and size of the bristles, all brushes generally suffer from a common problem. After each application of makeup using a brush, the brush accumulates “dirt” that decreases the brushes' further usefulness unless that brush is cleaned. This dirt has many origins. For example, some of the dirt is makeup that remains on the bristles of the brush after the majority of the makeup is applied to the skin. Furthermore, during each application, the brush absorbs oils present on the makeup recipient's skin, including both oils secreted by the skin and oils from lotions and creams applied to the skin. Other body fluids, such as sweat, tears, or saliva present on the skin can also be absorbed by the brush bristles. In addition, dead skin cells and bacteria present on the skin, including pathogenic bacteria, can also be transferred to the bristles during application of the brush. As a result of absorbing all of these substances, a brush becomes unsanitary after a single use, with the dirt on the brush being able to clog skin pores and even spread skin conditions. Such dangers are especially apparent when a single brush is used to apply makeup to different people, such as when a single makeup artist applies makeup to members of a bridal party in preparation for a wedding ceremony. In such a situation, if one of the members of the bridal party has a skin condition, such as an acne rash, shared cosmetic brushes can spread the condition to other members of the party. Further, the accumulation of dirt on a brush can prevent makeup from evenly adhering to the brush, and thus using the brush to apply makeup becomes challenging.

Conventional cosmetic brush cleaning techniques leave much to be desired. For example, one cleaning technique involves rinsing, such as in a bowl, the brushes with water, shampoo, or both, and leaving the brushes to air dry. However, such rinsing may not always remove all of the dirt trapped between the bristles. Furthermore, the air drying requires significant time, usually being done overnight, and thus is unsuitable for occasions when a single brush must be used on multiple people in a short span of time, such as during a wedding preparation or in a makeup salon. Finally, the prolonged exposure to liquid during the drying can loosen the glue that hold the bristles in the brush, accelerating the time when the brush needs a replacement, which can be costly.

Accordingly, there is a need for a fast and effective way to clean cosmetic brushes.

### SUMMARY

An assembly that can allow easier and more effective cleaning of cosmetic brushes is provided. Washing of brushes is performed within a cleaning chamber using rotation of a holder of cosmetic brushes, with brushes coming into a contact with a washing medium and semi-rigid filament that facilitate removal of dirt during the rotation. The washing medium is pumped into the cleaning chamber from one chamber of a reservoir, and is pumped after being used from the cleaning chamber into a different chamber of the reservoir. The base of the assembly includes components that allow controlling the operations of the assembly, either manually or using one or more preprogrammed routines. An additional compartment is provided for storing cosmetic brushes and washing accessories, such as soap bottles.

In one embodiment, a cosmetic brush cleaning assembly is provided. The assembly includes: a motor coupling comprising a cavity formed on at least one end and a base that includes a motor comprising a shaft shaped to mechanically couple to the motor coupling at a different end of the motor coupling, the motor configured to rotate the motor coupling in two directions when the motor coupling is coupled to the motor shaft. The assembly further includes a holder of at least one cosmetic brush, the holder including a rotatable shaft a portion of which is shaped to insert into the motor coupling cavity, the holder further including a protrusion formed on the holder shaft, the protrusion shaped to be secured in a portion of the motor coupling when the motor coupling rotates in one of the directions, causing a rotation of the holder in the one direction when the motor coupling rotates in the one direction, and to move to a different portion of the motor coupling when the motor coupling rotates the holder in another one of the directions, wherein a position of the shaft portion within the cavity changes upon the move. The assembly further includes a structure attached to the base on which are positioned a plurality of semi-rigid filaments shaped to come in contact with at least some bristles of the at least one cosmetic brush when the protrusion is secured against the portion of the motor coupling and the holder rotates in the one direction and to avoid contact with the bristles when the protrusion moves to the different portion and the cosmetic brush holder rotates in the another direction. The assembly further includes a cleaning chamber housing shaped to form a part of a cleaning chamber upon removably attaching to the base, the chamber shaped to enclose the structure and the cosmetic brush holder when attached to the motor coupling, and to hold a washing medium. The assembly further includes a washing medium reservoir attached to the base and including an unused washing medium chamber and a used washing medium chamber; a pump housed in the base and connected to the cleaning chamber and the unused medium reservoir via hoses, the pump configured to pump the washing medium from the unused washing medium chamber into the cleaning chamber prior to the rotation of the holder in the one direction, wherein the washing medium comes in contact with at least a portion of the bristles during the rotation of the holder in the one direction; and another pump housed within the base and connected to the cleaning chamber and the used washing medium chamber, the another pump configured to pump the washing medium from the cleaning chamber into the used washing medium chamber after the rotation of the holder in the one direction and prior to the rotation of the holder in the another direction.

Still other embodiments of the present invention will become readily apparent to those skilled in the art from the following detailed description, wherein is described embodiments of the invention by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF THE DRAWINGS

FIG. 1 is a diagram showing a perspective view of a cosmetic brush cleaning assembly, in accordance with one embodiment.

FIG. 2 is diagram showing certain disassembled components of the assembly, in accordance with one embodiment.

FIG. 3 is a diagram showing an exploded view of the motor coupling, in accordance with one embodiment.

FIG. 4 is a diagram showing disassembled parts of a holder of cosmetic brushes, in accordance with one embodiment.

FIG. 5 is a diagram showing the assembled cosmetic brush holder with one of the cosmetic brushes, in accordance with one embodiment.

FIG. 6 is a diagram showing the holder coupled to the motor coupling in position for washing cosmetic brushes, in accordance with one embodiment.

FIG. 7 is a diagram showing the coupled to the motor coupling in position for drying cosmetic brushes, in accordance with one embodiment.

FIG. 8 is a diagram showing a cross-sectional view of the base and the motor coupling within the base, in accordance with one embodiment.

FIG. 9 is a diagram showing a cross section a portion of one of the washing medium reservoirs and a cross-section of a portion of the middle plate together with components controlling flow of the washing medium in and out of the washing medium reservoir, in accordance with one embodiment.

FIG. 10 is a block diagram showing a system of electrical and electromechanical components of the assembly of FIG. 1, in accordance with one embodiment.

FIG. 11 is a flow diagram a method for cleaning cosmetic brushes using the cosmetic brush cleaning assembly of FIG. 1, in accordance with one embodiment.

### DETAILED DESCRIPTION

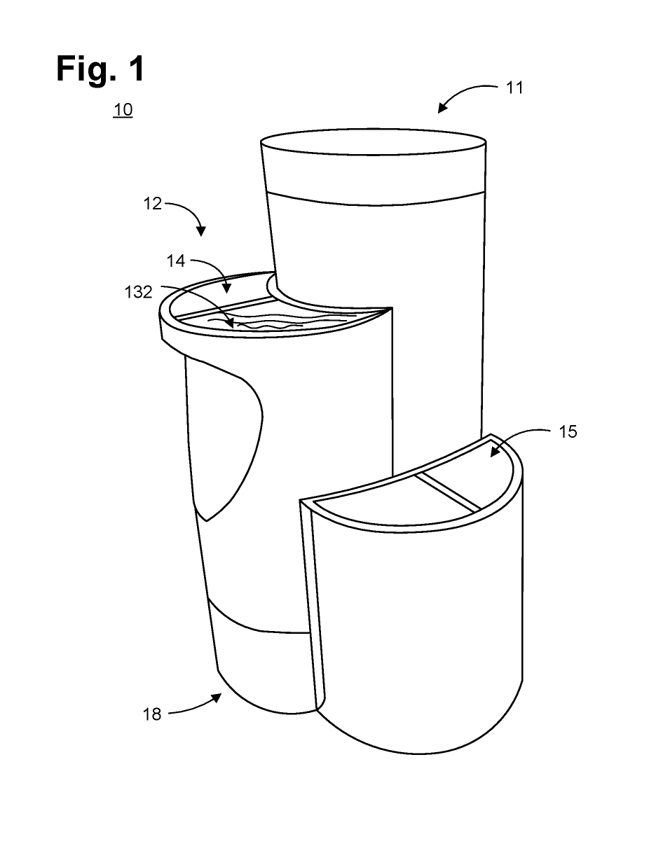

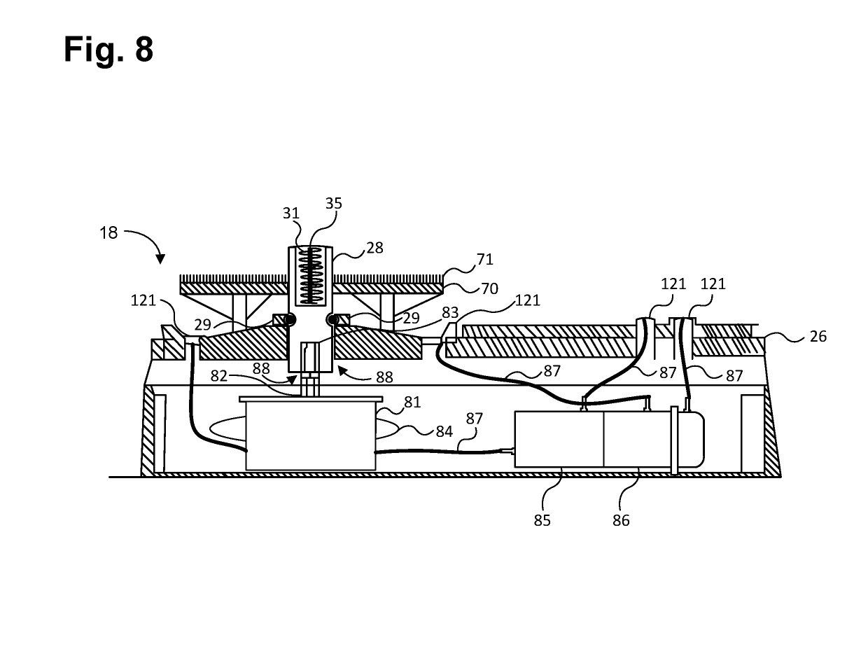

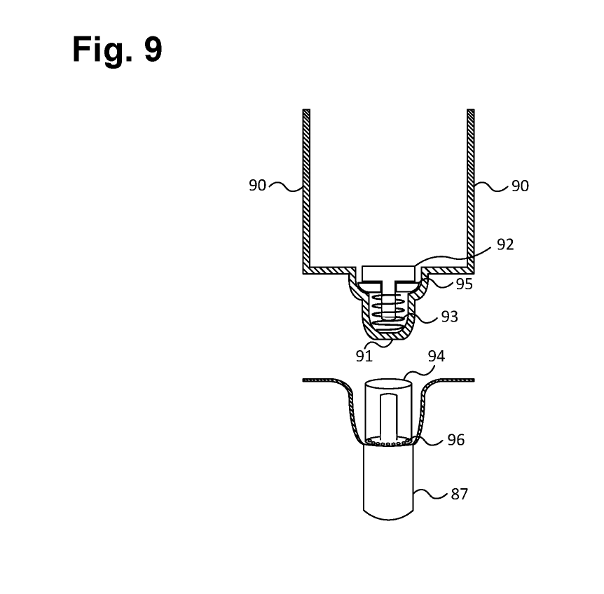

FIG. 1 is a diagram showing a perspective view of a cosmetic brush cleaning assembly 10, in accordance with one embodiment. The assembly 10 includes a cleaning chamber 11 where cosmetic brushes are washed using a washing medium 133 and dried after the washing medium 133 is removed. The assembly further includes a washing medium reservoir 12 that includes two chambers, each taking up half of the reservoir 12, though in a further embodiment, other allocations of space within the reservoir 12 are possible: a chamber 13 for storing washing medium that has not yet been used to clean cosmetic brushes (unused washing medium chamber 13″) and from which the washing medium is pumped into the cleaning chamber 11, as further described below with reference to FIGS. 8 and 9, and a chamber 14 into which the washing medium is pumped from the cleaning chamber 11 after being used to wash one or more cosmetic brushes (“used washing medium cleaning chamber 14”), as further described with reference to FIGS. 8 and 9. While shown in particular orientation to each other, in further embodiment, the chambers 12, 13 can be on left or right side of each other. As seen with reference to FIG. 1, the washing medium reservoir 12 is shaped to adjoin the cleaning chamber on one side; in a further embodiment, other shapes of the reservoir 12 are possible. The washing medium 133 can include liquids, such as water, either pure or mixed with other substances, such as shampoos or disinfecting reagents. Other kinds of the washing mediums 133 are possible. In addition, as described below, the bottom surface of the reservoir 12 includes holes 91 that are used as inlets and outlets for pumping the washing medium 133 in and out of the chambers 13, 14, as further described below with reference to FIG. 9.

The assembly 10 can further include a compartment 15 for storing cosmetic brushes and other cleaning accessories (such as soap bottles). The compartment can have multiple pockets 16, 17; in a further embodiment, the compartment can include only a single pocket. As seen with reference to FIG. 1, the compartment 15 is shaped to adjoin the washing medium reservoir 13 and the cleaning chamber 11 on one side; in a further embodiment, other shapes of the reservoir 12 are possible.

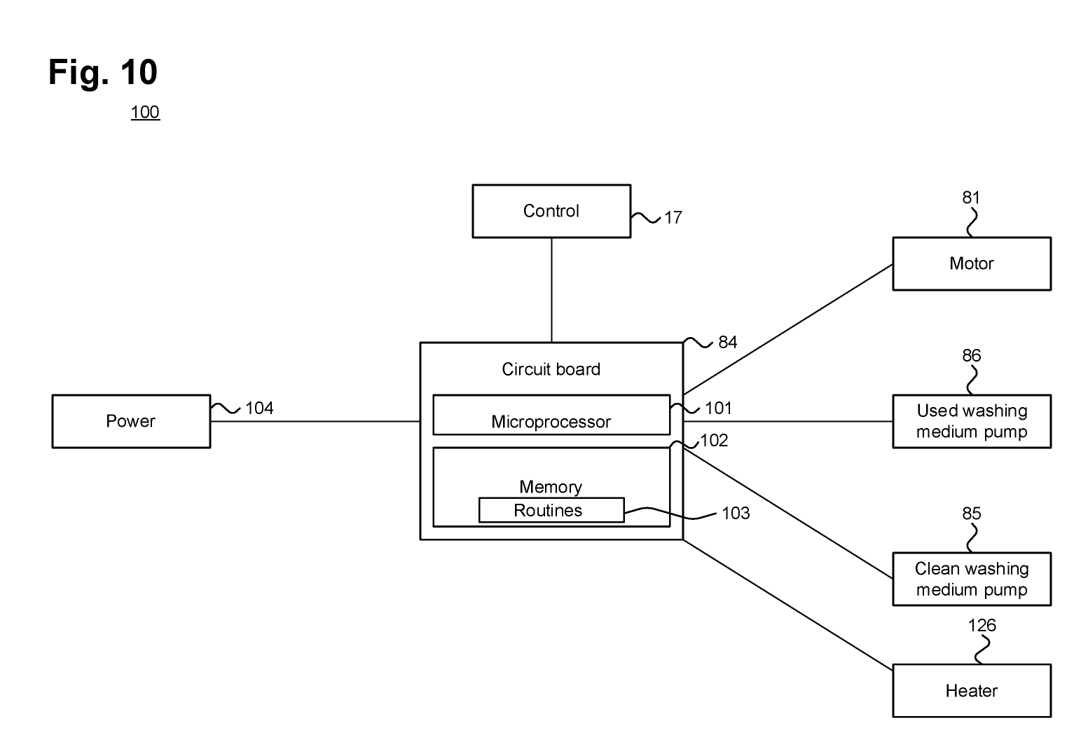

The assembly 10 further includes a base 18 which houses components controlling operation of the assembly 10, such as at least one circuit board, at least one motor, pumps, and wiring connecting the components, as further described below with reference to FIG. 10. Externally, the base 18 can house one or more controls 19 of the assembly 10. For example, as shown with reference to FIG. 1, the control 19 can be a button that a user presses to activate particular functionality of the assembly 10. In a further embodiment, other kinds of controls 19 are possible. For example, the control 19 can include a touch screen user interface presented on a touch screen (not shown) incorporated into the base. In a still further embodiment, the control 19 can be remote from the base, such as being incorporated into a remote controller (not shown), and connected to the base 18 either wirelessly, through wireless transceivers in the base 18 and a control 19, or through wires.

The storage compartment 15 can be fixedly attached, such as being bolted, or by being integrally formed as part of the base 18. In a further embodiment, the storage compartment 15 can be removably attachable to the base 18, such as using magnets (not shown) attached to the base 18 and the storage compartment, or by using a rotate-lock mechanism, or another fastening mechanism). The washing medium reservoir 13 is also removably attached to the base 18, such as using magnets or a rotate-lock mechanism, though other fastening mechanisms are possible.

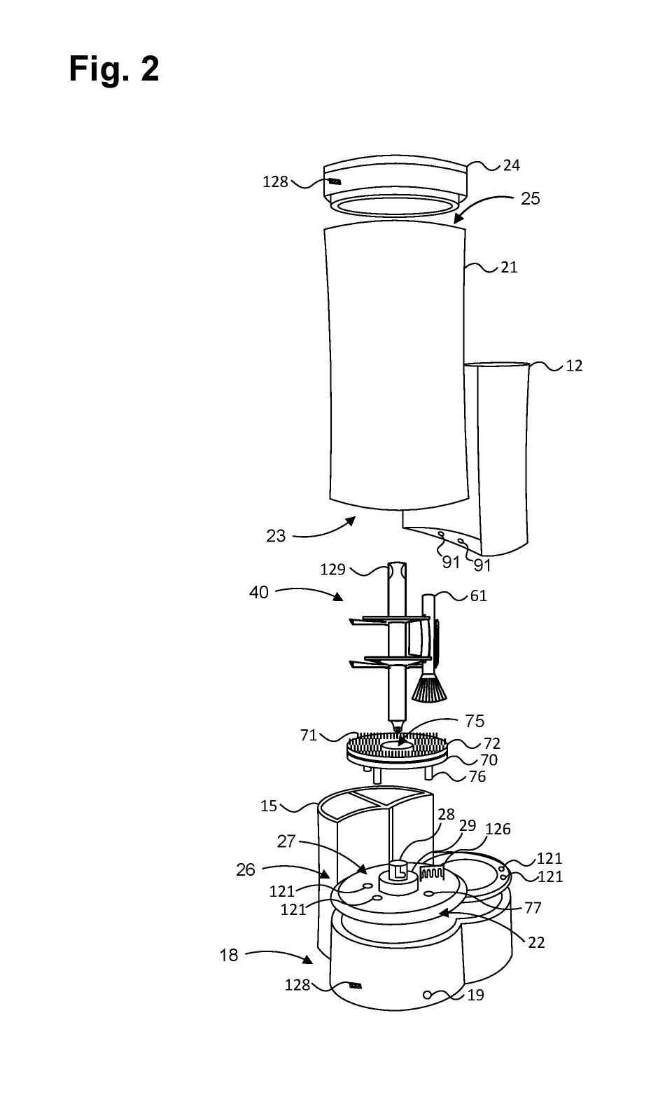

A portion of the base also serves as a portion making up the cleaning chamber 11. As further described below with reference to FIG. 2, the cleaning chamber is formed by the cleaning chamber housing coupled with a cleaning chamber lid removably attaching to the base 18, thus creating an enclosure that can hold the washing medium 133.

FIG. 2 is diagram showing certain disassembled components of the assembly 10, in accordance with one embodiment. As mentioned above, the cleaning chamber 11 includes a housing 21 that removably couples to a portion 22 of the base 18 at one end 23 and to a lid 24 at another end 25. As shown with reference to FIG. 2, the housing can be a hollow cylinder that has openings on both ends. In a further embodiment, instead of having the lid 24 as a separate component, one of the ends 25 of the housing 21 can be closed-ended and the lid 24 to create the cleaning chamber 11 is not necessary.

The housing 21 can couple to the portion 22 of the base in a plurality of ways. For example, the end 23 of the housing 21 and the portion 22 can include matching threads (not shown) that can be used to attach the housing 21 to the portion 22 of the base using a rotating motion. Alternatively, the portions 22 and the end 23 couple via magnets, or via a rotate-lock mechanism. Similarly, the end 25 of the housing that couples to the lid 24 could perform the coupling via matching threads on the end 25 and the lid 24 or via magnets (not shown) on the housing end 25 and the lid 24.

The portion 22 of the base 18 that couples to the housing 21 is a part of a plate 26 (“middle plate 26”), and in one embodiment, is removable from other portions of the base 18, such as via unscrewing bolts attaching the middle plate 26 to the reminder of the base 18. In a further embodiment, the middle plate 26 can be an integral part of the base 18. The portion 27 of the middle plate 26 that is enclosed by the housing 21 when the housing 21 is coupled to the base 18 has a circular opening (shown below with reference to FIG. 8) for a motor coupling 28, as further described below with reference to FIG. 8. The portion 27 includes holes 121 into which hoses 87 connected to pumps 85, 86 connect and can pump the washing medium 133 into the washing chamber. While the holes 121 are shown in a particular position on the portion 27 with reference to FIG. 1, other positions are possible. In one embodiment, the portion 27 can have a slight draft (such as a 2 degree angle) towards the holes 121 to facilitate drainage of the washing medium 133. In a further embodiment, the surface of the portion 27 can be flat.

Also, in a further embodiment, a water-resistant heater 127, such as a heating coil can be included on the portion 27, with the heater 127 being used to speed up the drying of brushes. Additionally, vents 128 can be included in the lid 24 (or another portion of the cleaning chamber 11) to allow evaporated washing medium to escape. In addition, such vents 128 can be included in the base 18 to facilitate cooling of electrical components of the base 18.

The washing medium reservoir also couples to the middle plate 26. The portion 128 that couples to the reservoir 12 also includes holes 121 that align with the holes 91 within the reservoir 12, and allow the washing medium 133 to enter and leave the reservoir 12, as further described with reference to FIG. 9. The motor coupling 28 is secured to the portion 27 using a radial shaft seal 29, which allows the motor coupling 28 to rotate within the opening shown below with reference to FIG. 8 while also preventing the washing medium 133 from escaping into an inside of the base 18. Other ways to prevent the escape of the washing medium 133 into the base 18 are possible.

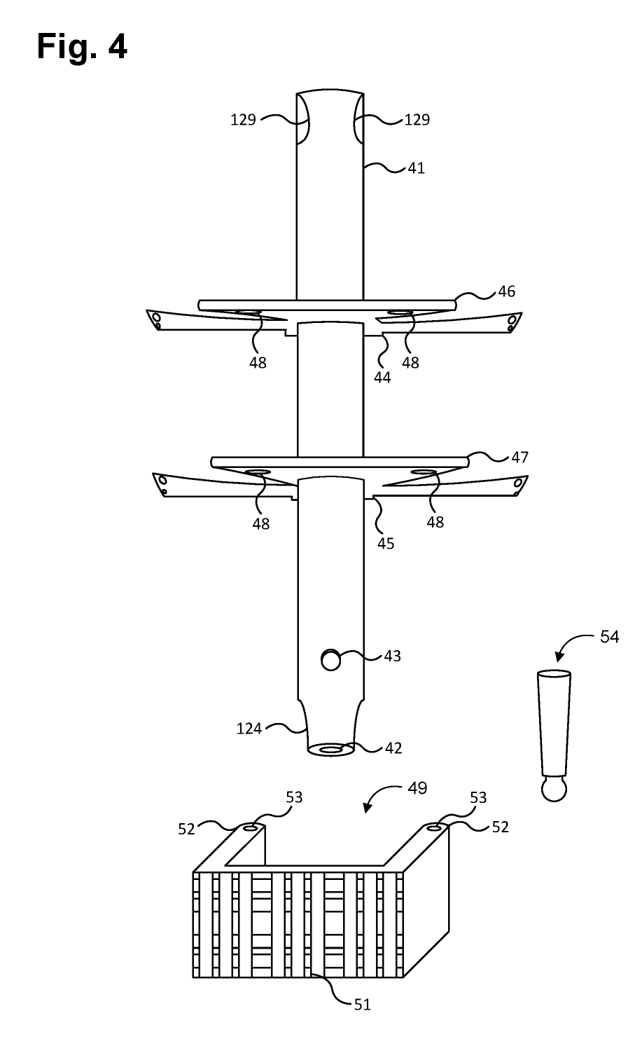

A holder 40 of one or more cosmetic brushes 61 can couple with the motor coupling, as further described below with reference to FIGS. 4-6. Once the holder 40 is coupled within the motor coupling 28 and the motor coupling 28 is in turn coupled to the motor within the base 18, the motor can cause the motor coupling and the attached holder 40 to rotate in two directions, with one direction being used for washing the brush with the washing medium 133 and the other direction being used to dry the brush 61.

The assembly 10 further includes a structure 70 on a surface of the middle plate 26 on which are positioned a plurality of semi-rigid filaments 71 that contact the brush when the brush is washed with the washing medium, as further described below. The semi-rigid filaments 71 can either be permanently attached to the structure 70, or be removably attached. For example, the filaments 71 can be attached to a pad 72 that has protrusions (not shown) shaped to fit (holes not shown) within the structure 70; the pad 72 can securely attach to the filaments structure 70 when the protrusions are inserted into the holes. The semi-rigid filaments 71 positioned on one structure 70 can be of different sizes, allowing different the filaments 71 to provide different levels of contact with the same brush 61. In a further embodiment, different pads 72 could also include filaments of a uniform size, but with the size of the filaments 72 varying between the pads 71.

The structure 70 includes an opening 75 wide enough for the structure 70 to be placed above the motor coupling 28 and to allow the holder 40 to insert into the motor coupling 28 through the opening 75. The structure 70 is attached to the middle plate 26 either permanently, such as being bolted down, or by having limbs 76 that are shaped to couple to holes 77 within the middle plate 26.

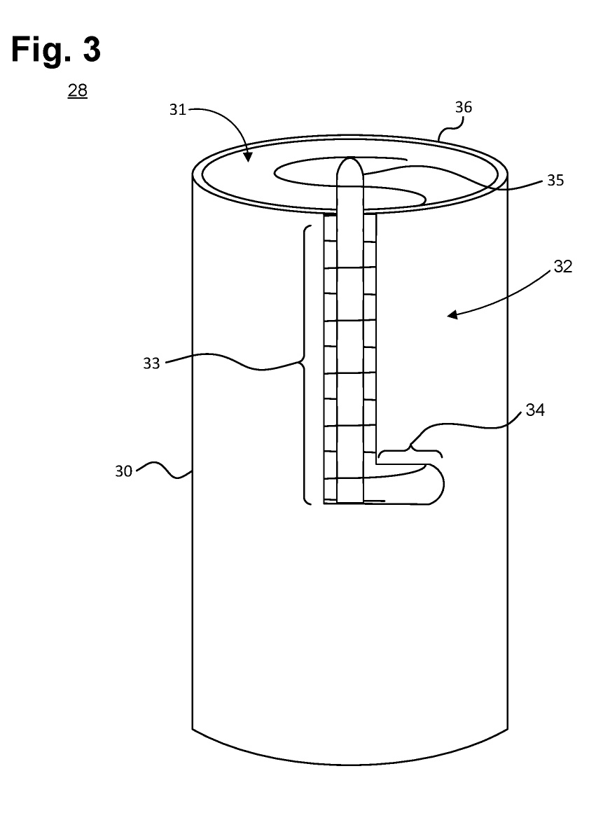

The motor coupling 28 can be rotated by a motor within the base 18, in turn rotating the in the base and a holder 40 of cosmetic brushes, as described below. FIG. 3 is a diagram showing an exploded view of the motor coupling 28, in accordance with one embodiment. The motor coupling 28 includes a housing 30, which can be a cylindrical housing though other shapes are possible. The housing 30 defines a cavity 31 at one end for coupling with the holder of cosmetic brushes (shown below) and a cavity at an opposite end for mating with a shaft of the motor comprised within the base 18 (shown below with reference to FIG. 8), the motor and the opposite end housing being shown further below. An L-shaped slot 32, is defined within the portion of the housing that defines the cavity 31. The L-shaped 32 slot is composed of two slots 33, 34: one slot 33 going from the edge of the portion of the housing 30 forming the cavity 31 towards the bottom of the cavity 31 (“vertical slot 33”); and a second slot 34 traverse to the first slot (“horizontal slot 34”). While the horizontal slot 34 is shown as being to the right of the vertical slot 33, in a further embodiment the horizontal slot 34 can be to the left of the vertical slot 33.

The motor coupling 28 further includes a rod 35 that is attached to the bottom of the cavity 31 and a spring 36 that coils around the rod 35. In one embodiment, the spring 36 in a removable spring 36; in a further embodiment, the spring 36 is permanently attached to the bottom of the cavity 31.

The rod 35 helps secure the holder of cosmetic brushes within the cavity. FIG. 4 is a diagram showing disassembled parts of a holder 40 of cosmetic brushes, in accordance with one embodiment. The holder includes a rotatable shaft 41 that includes a tapered tip 124 ending with a cavity 42 shaped to couple to the rod 35. The shaft 41 can also optionally include grooves 129 to make the shaft convenient to be grabbed by a user's fingers. A protrusion 43, such as a knob, that is shaped to fit within the slot 32 is formed on the portion of the shaft 41 that inserts into the slot 32. While the shaft 41 as cylindrical, other shapes of the shaft, such an elongated polygon, are also possible. Two flanges 44, 45 which can be circular though other shapes are also possible, are formed on the shaft 41, one flange 44 (“top flange”) being further away from the end of the shaft 41 that forms the cavity 42 than the other flange 45 (“bottom flange 45”). Multiple pairs of blades 46, 47 are attached to each of the top 44 and bottom 45 flanges. In each of the pairs, one of the blades 46 (“top blade 46”) is formed on the top flange 44 and the second blade 47 (“bottom blade 47”) is formed on the bottom flange 47 directly below (closer to the end of the shaft that forms the cavity) the top blade 46 in the pair. All of the top blades 46 are the same distance from the end of the shaft 41 that includes the cavity 42; similarly, all of the bottom blades 47 are the same distance from the end of the shaft 41 that includes the cavity 42. The distance between different pairs of blades 46, 47 along the circumference of the shaft 41 can vary. In a further embodiment, instead of being formed on the flanges 44, 45, the blades 46, 47 can directly form on the shaft 41 and the flanges 44, 47 can be absent. In a still further embodiment, the blades 46, 47 can removably attach to the rotatable shaft 41 or the flanges 44, 45.

The blades 46, 47 become wider as they extend further from the rotatable shaft 41, creating a space between the blades of different pairs that can accommodate a handle of a cosmetic brush. In a further embodiment, other shapes of the blades 46, 47 are possible.

Each of the blades 46, 47 further includes two apertures 48 that a rubber grip 49, the apertures 48 on all top blades 46 in a pair being aligned with the apertures of the bottom blades 47 in that pair.

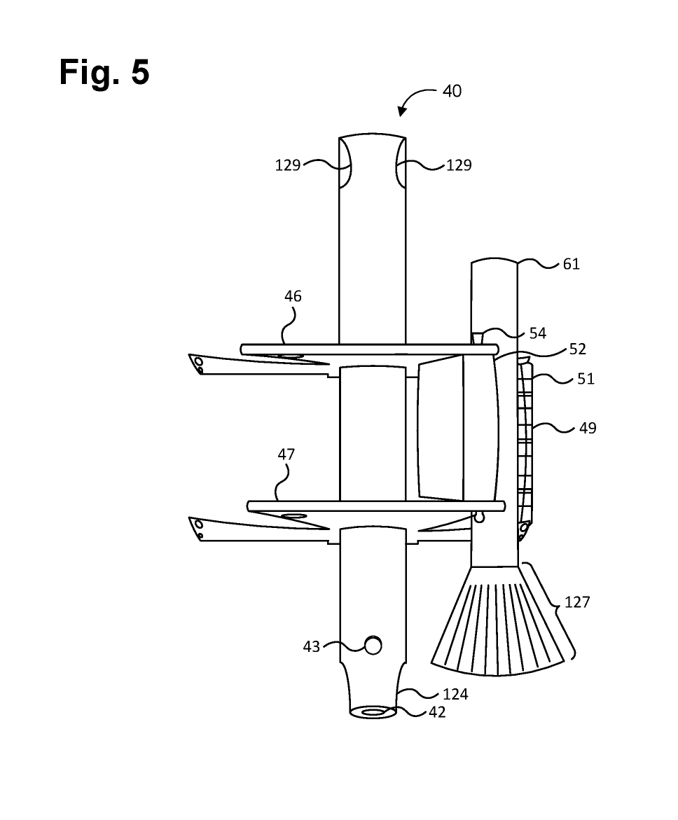

The rubber grip 49 can removably mounted to two of the blade pairs at once and secure a cosmetic brush between the blade pairs. The grip 49 includes an elastic band 50 at least one side of which is covered with a plurality of protrusions 51. While the protrusions 51 are shown to be forming a certain design, in a further embodiment, other protrusions 51 and patterns of protrusions 51 are possible. The opposite side of the elastic band 50 is joined to two connecting members 52 that include pieces of rubber with apertures 53 for attaching to the blades. In a further embodiment, additional apertures (not shown) can be included in the connecting members 52 to improve the flexibility of the members. The connecting members 52 can be formed out of the same piece of a rubber as the elastic band 49; in a further embodiment the connecting members 52 are removably attached to the elastic band 50. When the connecting members' apertures 53 are aligned with apertures 48 in blades 46, 47, the grip 49 is pivotably mounted between four blades 46, 47 using two pins 54. Each of the pins 54 is inserted into the connecting member aperture 53, and the apertures 48 of top 46 and bottom 47 blades in the same pair, as shown below with reference to FIG. 5. The pins 54 can be tapered towards the end that goes through the bottom blade apertures 48, though in a further embodiment, different shapes of the pins 54 are possible.

FIG. 5 is a diagram showing the assembled cosmetic brush holder 60 with one of the cosmetic brushes 61, in accordance with one embodiment. When pivotably mounted on the two pairs of blades 46, 47, the elastic band 50 can take multiple positions. In one position, when the connecting members 52 are completely parallel to each other, the elastic band 50 is completely straight, with the side covered with protrusions facing away from the rotatable shaft 41. When a handle of a cosmetic brush 61 is pushed against the elastic band 50, the elastic band 50 starts moving towards the rotatable shaft 41, which causes the connecting members 52 to pivot on the pins 54 and brings additional portions of the side of the elastic band 50 that is covered with protrusions 51 into contact with the handle of the brush 61. When the connecting members 52 have fully pivoted, the protrusion-covered side of the elastic band 50 contacts at multiple sides of the cosmetic brush 61, defining a “pocket” between the between the blades 46, 47 of the pairs to which the rubber grip 49 is attached in which the grip is secured. The size of the pocket that can be formed depends on the distance between the pairs of blades 46, 47, which can vary, and the size of the grip 49, which can also vary to accommodate brushes 61 of different size. The protrusions 51 help prevent the rubber grip from slipping from the grip 49.

While FIG. 5 show a single rubber grip 49 used for securing a single cosmetic brush 61 in the holder 40, multiple rubber grips 47 can be used to secure multiple cosmetic brushes 61. As mentioned above, each of the blades includes two apertures 46. Thus, three pairs of blades 46, 47 can be used to pivotally mount two rubber grips 49 and used to secure two cosmetic brushes. Further, as mentioned above, the distances between the pairs of blades 46, 47 along the circumference can vary, allowing to accommodate mounting grips 49 of different sizes between the pairs of blades 46, 47, and thus allowing to secure brushes 61 of different sizes in the grip 49.

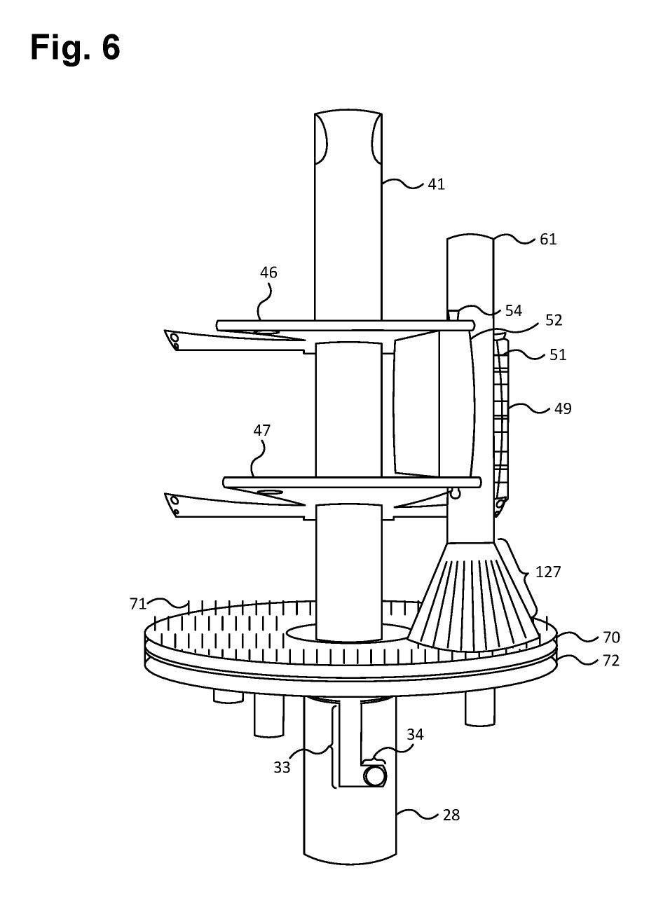

The coupling of the rotatable shaft 41 to the motor coupling 28 that can be rotated by the motor in the base allows the motor to rotate the holder 40 the holder 40 as a whole in two directions, with rotation in one direction being employed to wash the cosmetic brush 61 in the washing medium and the rotation in the second direction being used to dry the brushes. FIG. 6 is a diagram showing the holder 40 coupled to the motor coupling 28 in position for washing cosmetic brushes 61. A part of the rotatable shaft 41 is shaped to snugly fit within the cavity 31 of the motor coupling 28, with the protrusion 43 fitting into the L-shaped slot 32 when the rotatable shaft 41 is inserted into the cavity 31. When the shaft 41 is inserted into the cavity 31, the rod 35 enters the cavity 42 within the shaft 41, thus allowing the shaft 41 to travel along a straight line along the length of the rod 35. Further, when the shaft 41 is inserted into the cavity, the spring 36 surrounding the rod 35 is compressed as the shaft 41 travels along the length of the rod 35, pushing against the shaft 35.

As mentioned above, when a brush 61 is washed the bristles come in contact with semi-rigid filaments 71 positioned on the structure 70 and accordingly, the shaft 41 needs to be secure enough within the coupling to both not get displaced by the rotation and by the contact with the semi-rigid filaments 71. To secure the shaft 41 within the motor coupling 28 for that motion, a user needs to push the shaft 41 into the cavity 31 to bring the protrusion 43 to the point in the L-shaped slot 32 where the vertical slot 33 joins the horizontal slot 34, and then twist the shaft 41 to move the protrusion 43 into the vertical slot 33, the position shown in FIG. 6. Once in the vertical slot 33, the shaft 41 (and consequently the holder 40) is secured within the slot 34 due to the pressure exerted by the spring 36 against the upper (furthest from the bottom of the cavity 31). Further, as the motor coupling 28 begins rotating into the direction opposite to the direction in which the protrusion 43 was moved into the horizontal slot 34, the protrusion 43 is pushed horizontally against the surface of the horizontal slot furthest from the vertical slot 33, further securing the shaft 41 within the motor coupling 34. Thus, for example, if the protrusion 43 was initially rotated counterclockwise into the horizontal slot 34, the rotation of the motor coupling 28 in the clockwise direction would further secure the shaft 41 within the motor coupling 28.

During the rotation of the motor coupling 28 and the holder 40, the cosmetic brushes 61 secured in the holder 40 also rotate. When the protrusion 43 is within the horizontal slot 34, the bristles 127 of the cosmetic brushes 61 secured within the holder 61 are low enough to come into contact with the semi-rigid filaments 71 as the brush 61 rotates during the rotation of the holder 40. As used in this application, the term “semi-rigid” refers to the filaments 71 being rigid enough to move the bristles 127 when contacting them, but flexible enough to bend if the bristles are for some reason rendered immobile. For example, if multiple bristles are stuck together and rendered substantially immobile, the filament would bend and continue moving past the stuck bristles rather than tearing the bristles. In one embodiment, the filaments 71 can be made of rubber. In a further embodiment, other materials are possible.

As the cosmetic brush bristles 127 move through the semi-rigid filaments 71 during the rotation, the contact moves the bristles 127 away from one or more other nearby bristles, temporarily exposing different portions of the surfaces of the bristles 127 to the washing medium 133 and allowing the washing medium 133 to remove the dirt from the exposed surface without the dirt sticking to nearby bristles 127, allowing to remove the dirt that would have been otherwise trapped between the bristles 127. The washing medium 133 is in turn agitated by the rotation of the holder 40, raising the level of the medium 133 in the cleaning chamber 11, with the movement of the medium 133 facilitating the removal of the dirt from the bristles 127.

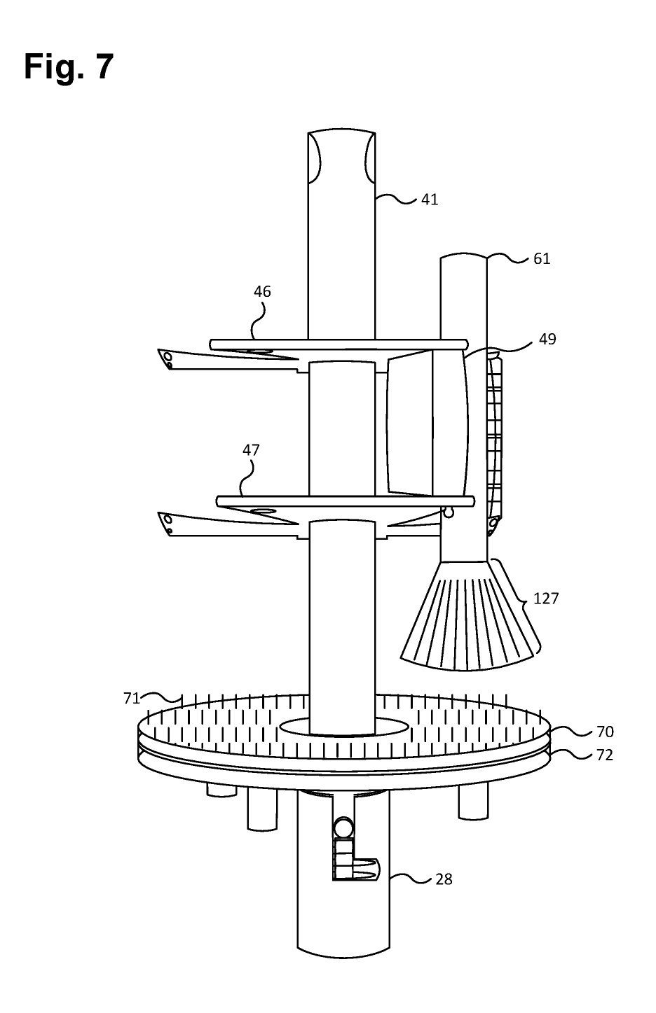

As the rotation through the semi-rigid filaments may over time weaken and loosen the glue that hold the bristles in the brushes 61, to best preserve the brushes 61, the brushes 61 are not in contact with the semi-rigid filaments during the drying of the brushes. FIG. 7 is a diagram showing the 40 coupled to the motor coupling 28 in position for drying cosmetic brushes 61, in accordance with one embodiment. When the washing of the cosmetic brushes with the medium is finished and the washing medium 133 is pumped out from the cleaning chamber 11, the motor starts rotating the motor coupling 28 starts rotating in the direction opposite to the direction the motor coupling 28 rotated during the washing. The rotation causes the protrusion 28 to escape from the horizontal slot 34 and into the vertical slot 33, at which point, the compressed spring would push the shaft 41 further up within the cavity 31 (away from the bottom of the cavity 31), with the protrusion 43 moving up the vertical slot 33. The weight of the holder 40 will prevent the spring from completely escaping from the cavity 31, but at this higher position of the holder, the bristles of the brush 61 no longer come in contact with the semi-rigid filaments 71. Further, the rotation causes the protrusion 43 to press against one of the sides of the vertical slot 33, securing the shaft within the slot for the duration of the rotation. Thus, the assembly 10 can switch from washing the cosmetic brushes to drying the brushes without user assistance.

Even without contacting the filaments 71, the rotation of the cosmetic brushes through air within the cleaning chamber increases the rate at which the residual washing medium is removed from the filaments on the filaments 71 when compared to when the brushes 61 remain stationary. Further, the rotation will generate heat that will accelerate the drying. In addition, as further described below, a heater 127 is included in the portion 27 enclosed by the cylinder.

The components within the base 18 control operations of other components of the assembly 10. FIG. 8 is a diagram showing a cross-sectional view of the base 18 and the motor coupling 28 within the base 18, in accordance with one embodiment. As mentioned above, the base includes 18 an electric motor 81 capable of rotating a motor shaft 82 in two directions. The motor 81 can be a stepper motor, though other kinds of motors are possible. The motor shaft 82 is shaped to mate with a cavity 83 at the end of the motor coupling 28 opposite to the end that forms the cavity 42. For example, the motor shaft 82 shaft can be octagonal and the cavity 83 can be octagonal and shaped to receive the octagonal shaft. Other shapes of the cavity 83 and the motor shaft 82 are possible. For instance, the cavity 83 and the motor shaft 82 can be cylindrical. Still other shapes are possible. The motor coupling 28 is secured within the opening 88 within the middle plate 26 by a radial shaft seal 29, which allows the motor coupling to rotate within the opening while preventing the washing medium 133 from escaping into the inside of the base 18.

The base 18 includes a circuit 84 that includes a microcontroller and a memory, as further described below with reference to FIG. 10. If the circuit 84 is donut-shaped, the circuit board 84 can be placed around the motor 81 to conserve space within the base 18, though other locations of the circuit within the base 18 base are possible. The base 18 further includes at least two pumps 85, 86 that are connected by hoses 87 to the holes 91 within the reservoir 12 and holes 121 within the middle plate 26. The hoses 87 are tipped by the nozzles (shown with reference to FIG. 9) that connect can enter through both the hole 91 and the hole 121, as further described with reference to FIG. 9. One of the pumps 85 pumps the washing medium 133 from the unused washing medium chamber 13 into the cleaning chamber 11 before the holder 40 of the cosmetic brushes is rotated to bring the bristles 127 of the brush 61 in contact with the semi-rigid filaments 71, as described above with reference to FIG. 6. Following the rotation and before starting the rotation into the opposite direction, the pumps 86 pump the washing medium 133 out of the cleaning chamber 11 and into the used washing medium reservoir 14. The pumps 85, 86 can be peristaltic pumps, though other kinds of pumps are possible.

The washing medium reservoir 12 can be removed from the base 18 to remove used washing medium 133 from the used washing medium reservoir and to replenish the unused washing medium reservoir 133 with unused washing medium 133. Accordingly, upon removal from the base 18, the outlets of the unused washing medium chamber 12 need to be tightly capped to prevent spillage of the washing medium 133 from either of the chambers 13, 14 of the reservoir 12. FIG. 9 is a diagram showing a cross section a portion of one of the washing medium reservoirs 13, 14 and a cross-section of a portion of the middle plate 26 together with components controlling flow of the washing medium 133 in and out of the washing medium reservoir 12, in accordance with one embodiment. The housing 90 of the washing medium reservoir 12 includes at least two hole 91 that allows the washing medium 133 to enter and exit the two chambers 91. The housing 90 is tapered towards the hole 91 to facilitate drainage of the washing medium 133 from the reservoir. A plug 92 is positioned directly above each hole 91, and is attached to a spring 93 that is attached to the portion of the housing 90 surrounding the hole 91. Unless the plug 92 is pushed up, the plug 92 blocks the hole 91 and prevents the washing medium from escaping from the reservoir 12. In addition, an o-ring 95 is placed between the plug 92 and the spring 93 in each of the holes 91 to further prevent the escape of the washing medium.

As mentioned above, the hoses 87 are tipped with a needle-shaped nozzle 94. The nozzle can include additional holes 96 to facilitate drainage of the washing medium 133. When the reservoir 12 is attached to the middle plate 26, the nozzle 94 enters the hole 91 and pushes the plug 92 up, stretching the spring 93, allowing the washing medium to enter into the reservoir from the hose 87 or be pumped away through the hose 87. Once the reservoir 12 is removed from the base 18 (such as to throw out the used washing medium 133) and the nozzle 94 is no longer in contact with the plug 92, the plug 92 is pulled by the spring 93 into the original position, with the o-ring 95 helping the plug 92 prevent the washing medium 133 from escaping from the reservoir 12. The components described with reference to FIG. 9 can be used for exchanging the washing medium in both of the chambers 13, 14; in a further embodiment, other ways to exchange the medium 133 can be used.

The assembly 10 includes a plurality of electrical and electromechanical components that allow implementing the functions described above. FIG. 10 is a block diagram showing a system 100 of electrical and electromechanical components of the assembly 10 of FIG. 1, in accordance with one embodiment. As mentioned above, the base 18 houses a circuit board 84 that includes a microcontroller 101 that is connected, either electrically or wirelessly, to the and directs the operation of other components based on input from the control. The microcontroller 101 can include a central processing unit (not shown) capable of executing computer-executable code. The circuit board 84 also includes a memory 102, which can include both volatile, such as RAM, and non-volatile memory, such as flash memory. The code can be stored in the non-volatile portion of the memory 102 of the microcontroller 101, and can include one or more preprogrammed routines 103 that specify parameters for drying and washing the brushes 61. In a further embodiment, the memory 102 can be a part of the microcontroller 101. Still other kinds of the memory 102 are possible.

In one embodiment, each of the routines 103 specifies parameters for only washing or drying of brushes 61; in a further embodiment, one routine can specify parameters for both the washing and the drying and include instructions for the CPU to control various components of the system 100 based on the parameters. Such the parameters can describe the amount of time and particular intervals of time when the motor 81 rotates the rotatable shaft 41 through the motor coupling 28 in both directions; the speed of the rotation in both directions; and any times during the execution of the routines 103 when the washing medium 133 is exchanged through within the cleaning chamber 11; and the length for which the heater is turned on 127. Still other parameters are possible. The routines 103 can be selected by the user through the controls 19, allowing the user to elect the most appropriate way to wash and dry a particular type of brushes 102 without having to manually control the cleaning. The controls 19 can also direct the microcontroller 103 to rotation in one of the directions without having the microcontroller 101 activate one of the routines 53. For example, the microcontroller 101 can activate the motors 103 only while the user presses a button included in the controls 19.

The microcontroller 101 is electrically interfaced to the motors 81 and the pumps 85, 86 through wires (not shown). Further, the microcontroller 101 can be electrically interfaced to other components of the system 100, including the heating elements 127. Through the electrical connection, the microcontroller 101 can initiate or control execution of the routines 103 and control these components of the assembly 10.

Further, the circuit board 84 is interfaced to a power source 104, which provides power to the microcontroller 101. The power source 104 can be an electrical cord that is connected to the base 104 and that can be plugged into an electrical outlet, allowing the assembly to function without a battery. In a further embodiment, the power source 104 can include an internal battery. Still other kinds of power supplies are possible. Through the electrical connections to other components of the assembly 10, the circuit board 84 provides the electrical energy received through the power source 104 to the components of the system 100, including the heater 127. In a further embodiment, the power source 104 could also directly electrically connected to other components of the system 100, powering the components. In a still further embodiment, multiple power sources 104 can be present, powering different components of the system 100 separately. In a still further embodiment, wireless communication is possible between different components of the system 100.

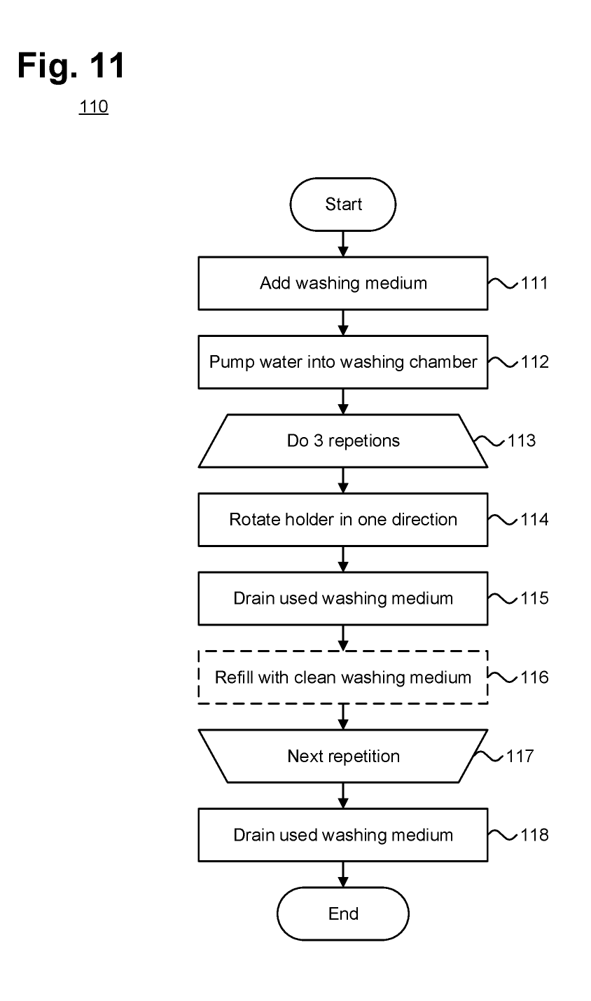

While the initial preparation of the assembly 10 for cleaning the brushes requires user input, once the initial set-up is done, the cleaning is performed by the assembly 10 autonomously. FIG. 11 is a flow diagram a method 110 for cleaning cosmetic brushes using the cosmetic brush cleaning assembly 10 of FIG. 1, in accordance with one embodiment. The assembly is prepared for cleaning cosmetic brushes 110 (step 111). In particular, the washing medium 133 is added to the unused washing medium chamber 13 in the reservoir 12 by the user and the reservoir 12 is attached to the base; cosmetic brushes 61 that need to be cleaned are inserted into the holder 40 and the holder is inserted into the motor coupling 28 in the position shown with reference to FIG. 6; and the cleaning chamber housing 11 and the lid 24 are attached to the base 18 to form the cleaning chamber 11. User input for activating one of the routines 103 is received through one of the controls (112). Washing medium 133 is pumped into the cleaning chamber 10 by the pump 85 in quantity sufficient to reach the bristles of the brush (113). A washing sequence (steps 113-117) is started (113), with the washing sequence being performed 3 times. In a further embodiment, a different number of times the washing sequence is performed are possible. The motor rotates the holder 114 in one direction (direction opposite to the direction the protrusion 43 was moved to enter the horizontal slot 34), with the cosmetic brushes contacting the filaments 71 on the structure during the rotations for a duration specified by the activated routine 110 (step 114). Washing medium (that now has the dirt from the brush bristles) is pumped out of the cleaning chamber by the pump 86 into the used washing medium reservoir 14 (step 115). Optionally, if the washing sequence is not being performed for the last time in the current routine 103, the cleaning chamber 10 is refilled with unused washing medium by the pump 85 (step 116). If the washing sequence is performed for the last time, step 116 is skipped. If the washing sequence has not been done three times, the routine returns to step 113 for a next repetition of the sequence (step 117). Following the completion of the programmed number of washing sequences, the motor starts rotating the holder in the direction opposite to the direction used during the washing sequences, which causes the holder 40 to assume the position shown with reference to FIG. 7, in which the bristles 127 do not come into contact with the filaments (step 118). Once the rotation is performed for a time predefined in the selected routine 103, which dries the brushes 61 in the holder 40, the method 110 ends. In a further embodiment, the drying can be performed by continuing rotation into the same direction as done during washing, with the filaments 71 contacting the bristles 127.

While the invention has been particularly shown and described as referenced to the embodiments thereof, those skilled in the art will understand that the foregoing and other changes in form and detail may be made therein without departing from the spirit and scope of the invention.

What is claimed is:

1. A cosmetic brush cleaning assembly, comprising:
a motor coupling comprising a cavity formed on at least one end;
a base comprising a motor comprising a shaft shaped to mechanically couple to the motor coupling at a different end of the motor coupling, the motor configured to rotate the motor coupling in two directions when the motor coupling is coupled to the motor shaft;
a holder of at least one cosmetic brush, the holder comprising a rotatable shaft a portion of which is shaped to insert into the motor coupling cavity, the holder further comprising a protrusion formed on the holder shaft, the protrusion shaped to be secured in a portion of the motor coupling when the motor coupling rotates in one of the directions, causing a rotation of the holder in the one direction when the motor coupling rotates in the one direction, and to move to a different portion of the motor coupling when the motor coupling rotates the holder in another one of the directions, wherein a position of the shaft portion within the cavity changes upon the move;
a structures attached to the base on which are positioned a plurality of semi-rigid filaments shaped to come in contact with at least some bristles of the at least one cosmetic brush when the protrusion is secured against the portion of the motor coupling and the holder rotates in the one direction and to avoid contact with the bristles after the protrusion moves to the different portion and the cosmetic brush holder rotates in the another direction;
a cleaning chamber housing shaped to form a part of a cleaning chamber upon removably attaching to the base 18, the chamber shaped to enclose the structure and the cosmetic brush holder when attached to the motor coupling, and to hold a washing medium;
a washing medium reservoir attached to the base and comprising an unused washing medium chamber and a used washing medium chamber;
a pump housed in the base and connected to the cleaning chamber and the unused medium reservoir via hoses, the pump configured to pump the washing medium from the unused washing medium chamber into the cleaning chamber prior to the rotation of the holder in the one direction, wherein the washing medium comes in contact with at least a portion of the bristles during the rotation of the holder in the one direction; and
another pump housed in the base and connected to the cleaning chamber and the used washing medium chamber, the another pump configured to pump the washing medium from the cleaning chamber into the used washing medium chamber after the rotation of the holder in the one direction and prior to the rotation of the holder in the another direction.

2. An assembly according to claim 1, the motor coupling further comprising:
a motor coupling housing forming the cavity;
a rod formed at a bottom of the cavity and shaped to couple to a different cavity formed at an end of the rotatable shaft;
an L-shaped slot formed within the motor coupling housing and into which at least a portion of the protrusion inserts when the rotatable shaft portion is inserted into the motor coupling cavity, the L-shaped slot comprising a first slot in which the at least the portion of the protrusion remains during the rotation of the holder in the one direction and a second slot traverse to the first slot into which the at least the portion of the protrusion moves after the holder starts rotating into the another direction; and
a spring shaped to coil around the rod and that is compressed by the rotatable shaft when the protrusion is inserted into the second slot, the compressed spring pushing the protrusion away from the bottom of the cavity against a surface of the first slot during the rotation of the holder in the one direction, a release of at least a portion of the compression of the spring moving the rotatable shaft away from the bottom of the cavity once the protrusion moves into the second slot.

3. An assembly according to claim 2, wherein the rotation of the motor in the another direction causes the protrusion to move from the first slot into the second slot.

4. An assembly according to claim 1, further comprising:
a circular opening formed in a portion of the base to which the structure and the cleaning chamber housing attach, wherein the motor coupling is positioned within the opening when attached to the motor shaft; and
a seal in contact with the motor coupling and the portion that prevents the washing medium from escaping the cleaning chamber through the circular opening.

5. An assembly according to claim 4, wherein the seal is a radial shaft seal.

6. An assembly according to claim 4, wherein the portion of the base in which the opening is formed is comprised in a plate removable from remaining portions of the base.

7. An assembly according to claim 1, wherein the holder further comprises:
a plurality of pairs of blades connected to the rotatable shaft, each of the pairs comprising a top one of the blades that is further away from the portion of the rotatable shaft that contacts the motor coupling than a bottom one of the blades comprised in the pair, wherein all of the top blades are one distance from the rotatable shaft portion and all of the bottom blades are another distance from the rotatable shaft portion; and
at least one rubber grip comprising an elastic band covered with protrusions on one side and joined to two connecting members on another side, the two connecting members shaped to pivotably attach to top and bottom blades of two of the pairs, wherein a portion of a handle of one of the cosmetic brushes pressing against a portion of the protrusion-covered side of the elastic band pushes the portion of the elastic band towards the rotatable shaft, which urges the connecting members to pivot and bring additional portions of the protrusion-covered side in contact with the handle, securing the cosmetic brush between the two pairs of the blades.

8. An assembly according to claim 7, wherein a distance between one of the top blades and another one of the top blades differs from a distance between the one top blade and a different one of the top blades, and a distance between one of the bottom blades and another one of the bottom blades differs from a distance between the one bottom blade and a different one of the bottom blades.

9. An assembly according to claim 7, further comprising:
two flanges formed on the rotatable shaft, wherein the top blades are formed on one of the flanges and the bottom blades are formed on another one of the flanges.

10. An assembly according to claim 7, wherein the connecting members, the top blades, and the bottom blades comprise one or more apertures, and each of the connecting members is pivotably attached to one of the top blades and one of the bottom blades by inserting a pin into the aperture of that connecting member, the aperture of that top blade, and the aperture of that bottom blade.

11. An assembly according to claim 8, wherein the pin tapers from one end of the pin to another end of the pin.

12. An assembly according to claim 7, further comprising:
a tapered tip formed on the rotatable shaft and shaped to insert into the motor coupling cavity.

13. An assembly according to claim 1, further comprising:
a pad comprising the plurality of the semi-rigid filaments removably attachable to the structure (70).

14. An assembly according to claim 1, further comprising a lid shaped to removably couple to the cleaning chamber housing at an end different from an end at which the cleaning chamber housing couples to the base.

15. An assembly according to claim 1, further comprising:
one or more controls configured to receive user input; and
a microcontroller comprised in the base and electrically interfaced to the motor, the pumps, and the controls, the microcontroller configured to activate one or more of the pumps and the motor based on user input.

16. An assembly according to claim 15, further comprising:
a power source connected electrically connected to the microcontroller.

17. An assembly according to claim 15, further comprising:
a memory operatively coupled to the microcontroller, the memory storing one or more routines for controlling operations of the motor, the pumps, the controls, and a heater.

18. An assembly according to claim 1, further comprising:
a storage compartment formed on the base.

19. An assembly according to claim 1, further comprising:
one or more vents comprised in the cleaning chamber housing and the base.

20. An assembly according to claim 1, further comprising:
a heater comprised within the cleaning chamber.
